(19) United States
(12) Patent Application Publication
(10) Pub. No.: US 2007/0157951 A1
(43) Pub. Date: Jul. 12, 2007

(54) Systems and methods for processing microfeature workpieces

(75) Inventors: Kenneth A. Windley, Nampa, ID (US); Nathan E. Woolsey, Boise, ID (US)

Correspondence Address: PERKINS COIE LLP;PATENT-SEA, PO BOX 1247, SEATTLE, WA, 98111-1247, US

(73) Assignee: Micron Technology, Inc., Boise, ID (US)

(21) Appl. No.: 11/327,090

(22) Filed: Jan. 6, 2006

(51) Int. Cl. B08B 7/00; B08B 3/00

(52) U.S. Cl. 134/33; 134/34; 134/137; 134/155

(57) ABSTRACT

Systems and methods for processing microfeature workpieces are disclosed herein. In one embodiment, a system includes a processing vessel for receiving a plurality of microfeature workpieces, an inlet through which a processing fluid can flow into the processing vessel, and a workpiece mover for moving the microfeature workpieces in the processing vessel. The workpiece mover includes a first end portion configured to contact a peripheral edge of the individual workpieces, a second end portion opposite and positioned upstream from the first end portion, and a third portion between the first and second end portions. The first end portion has a first thickness, the second end portion has a second thickness, and the third portion has a third thickness greater than the first and second thicknesses.

### TECHNICAL FIELD

The present invention is directed to systems and methods for processing microfeature workpieces. More particularly, aspects of the invention are directed to systems and methods for rinsing and/or drying microfeature workpieces.

### BACKGROUND

Semiconductor devices and other microelectronic devices are typically manufactured on a wafer having a large number of individual dies (e.g., chips). Each wafer undergoes several different procedures to construct the switches, capacitors, conductive interconnects, and other components of the devices. For example, a wafer can be processed using lithography, etching, deposition, planarization, annealing, and other procedures that are repeated to construct a high density of features. One challenge in constructing devices on wafers is maintaining a generally contaminant-free surface on the wafer. For example, several operations, such as wet etching, photoresist stripping, and RCA cleaning, are completed with a chemical treatment. After the chemical treatment, the wafer must be (a) rinsed to remove the treatment chemicals and (b) dried to remove residual rinse water that could otherwise interfere with subsequent processing.

FIG. 1A schematically illustrates a conventional system 1 for rinsing a batch of wafers S (only one shown in FIG. 1A). The system 1 includes a tank 10, a wafer pusher 20 for pushing the wafers S in the tank 10, and an arm 80 for driving the wafer pusher 20. The tank 10 includes an inlet 14 for flowing deionized water (DI water) 12 into the tank 10 and an overflow opening 16 through which the DI water 12 exits the tank 10. FIG. 1B is a schematic side view of the wafer pusher 20 and the arm 80 taken substantially along the line A-A in FIG. 1A. Referring to both FIGS. 1A and 1B, the conventional wafer pusher 20 includes a flat proximal end 22 attached to the arm 80, a distal end 24 configured to contact the wafers S, a first surface 26 (identified as 26a-b in FIG. 1A) extending between the proximal and distal ends 22 and 24, and a second surface 28 (identified as 28a-b) extending between the proximal and distal ends 22 and 24. The first surface 26 includes (a) a flat proximal portion 26a oriented perpendicular to the flat proximal end 22, and (b) a distal portion 26b angled inward from the proximal portion 26a. The second surface 28 includes (a) a flat proximal portion 28a oriented perpendicular to the flat proximal end 22, and (b) a distal portion 28b angled inward from the proximal portion 28a such that the distal portions 26b and 28b intersect at the distal end 24. The arm 80 includes a first section 82, a second section 84 oriented perpendicular to the first section 82, and third and fourth sections 86a-b projecting from the second section 84. The third and fourth sections 86a-b space the wafer pusher 20 away from the second section 84 of the arm 80.

One drawback of the conventional system 1 illustrated in FIGS. 1A and 1B is that the flow of DI water 12 over the wafer pusher 20 and the arm 80 becomes turbulent. The turbulent flow of DI water 12 across the wafers S fails to remove the chemical treatment from portions of the wafers S, and in particular the portion proximate to the wafer pusher 20. As a result, several devices on the wafers S are defective because the chemical residue interferes with subsequent processes. Accordingly, there exists a need to improve conventional systems for rinsing wafers.

### BRIEF DESCRIPTION OF THE DRAWINGS

FIG. 1A schematically illustrates a conventional system for rinsing a batch of wafers.

FIG. 1B is a schematic side view of the wafer pusher and the arm taken substantially along the line A-A in FIG. 1A.

FIG. 2 is a schematic illustration of a system for rinsing and/or drying a plurality of microfeature workpieces in accordance with one embodiment of the invention.

FIG. 3 is a schematic side view of the workpieces, the workpiece mover, and the arm taken substantially along the line B-B of FIG. 2.

FIG. 4 is a schematic enlarged view showing a portion of the trailing end of the workpiece mover in greater detail.

FIG. 5 is a schematic side view of a workpiece mover and an arm for use in a system for rinsing and/or drying a plurality of microfeature workpieces.

### DETAILED DESCRIPTION

A. Overview

The following disclosure describes systems and methods for processing microfeature workpieces, including systems and methods for rinsing and/or drying microfeature workpieces. An embodiment of one such system includes a processing vessel for receiving a plurality of microfeature workpieces, an inlet through which a processing fluid can flow into the processing vessel, and a workpiece mover for moving the microfeature workpieces in the processing vessel. The workpiece mover includes a first end portion configured to contact a peripheral edge of the individual workpieces, a second end portion opposite and positioned upstream from the first end portion, and a third portion between the first and second end portions. The first end portion has a first thickness, the second end portion has a second thickness, and the third portion has a third thickness greater than the first and second thicknesses.

In another embodiment, a system includes a processing vessel for receiving a microfeature workpiece, an inlet through which a processing fluid can flow into the processing vessel, and a workpiece mover for pushing the microfeature workpiece in the processing vessel. The workpiece mover includes a trailing end portion configured to contact a peripheral edge of the workpiece and a leading end portion opposite the trailing end portion. The system further includes an arm coupled to the workpiece mover for driving the workpiece mover. The arm has a portion contacting and attached directly to the workpiece mover. The portion of the arm extends in a direction generally parallel to the leading end portion of the workpiece mover.

Another aspect of the invention is directed to microfeature workpiece movers for use in systems for rinsing and/or drying microfeature workpieces. The systems include a processing vessel in which a batch of microfeature workpieces can be immersed in a processing fluid. In one embodiment, a workpiece mover includes a first end portion configured to contact a peripheral edge of the individual workpieces, a second end portion opposite the first end portion, a first arcuate surface extending between the first and second end portions, and a second arcuate surface opposite the first arcuate surface and extending between the first and second end portions.

Another aspect of the invention is directed to methods for processing microfeature workpieces. In one embodiment, a method includes positioning a plurality of microfeature workpieces in a processing vessel, pushing the workpieces within the processing vessel with a workpiece mover, and flowing processing fluid across the workpieces with a laminar flow to remove chemical residue from the workpieces. Pushing the workpieces can include contacting a peripheral edge of the individual workpieces with the workpiece mover. The method may further include delivering deionized water to the processing vessel, and removing the workpieces from the processing fluid with the workpiece mover.

Another aspect of the invention is directed to methods for rinsing and/or drying microfeature workpieces. In one embodiment, a method includes positioning a plurality of microfeature workpieces in a processing vessel, moving the workpieces within the processing vessel with a workpiece mover, and flowing a processing fluid across the workpiece mover without changing the fluid flow from a laminar flow to a turbulent flow.

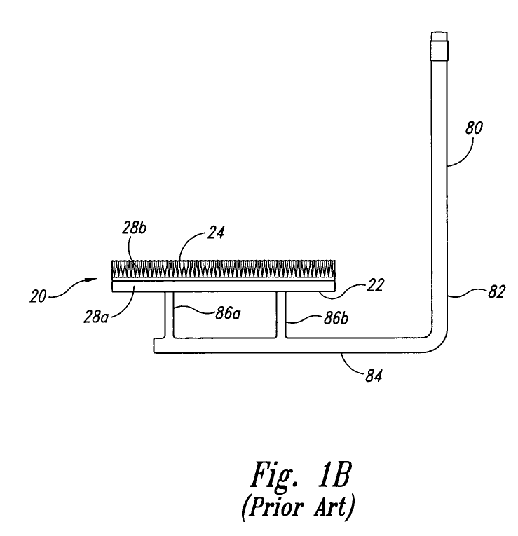

Specific details of several embodiments of the invention are described below with reference to workpiece movers for use in systems for rinsing and drying microfeature workpieces, but the workpiece movers can be used in other systems for processing microfeature workpieces. Several details describing well-known systems or processes often associated with rinsing and drying microfeature workpieces are not set forth in the following description for purposes of brevity and clarity. Also, several other embodiments of the invention can have different configurations, components, or procedures than those described in this section. A person of ordinary skill in the art, therefore, will accordingly understand that the invention may have other embodiments with additional elements, or the invention may have other embodiments without several of the elements shown and described below with reference to FIGS. 2-5.

The term “microfeature workpiece” is used throughout to include substrates upon which and/or in which microelectronic devices, micromechanical devices, data storage elements, optics, and other features are fabricated. For example, microfeature workpieces can be semiconductor wafers, glass substrates, dielectric substrates, or many other types of substrates. Many features on such microfeature workpieces have critical dimensions less than or equal to 1 μm, and in many applications the critical dimensions of the smaller features are less than 0.25 μm or even less than 0.1 μm. Where the context permits, singular or plural terms may also include the plural or singular term, respectively. Moreover, unless the word “or” is expressly limited to mean only a single item exclusive from other items in reference to a list of at least two items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same features and/or types of other features and components are not precluded.

B. Embodiments of Systems for Processing Microfeature Workpieces

FIG. 2 is a schematic illustration of a system 100 for rinsing and/or drying a plurality of microfeature workpieces W (only one shown in FIG. 2) in accordance with one embodiment of the invention. The illustrated system 100 rinses and dries the workpieces W to remove chemicals from the workpieces W after the workpieces W have completed a chemical process such as wet etching, photoresist stripping, and/or RCA cleaning. For example, the system 100 may include a Marangoni dryer. In the illustrated embodiment, the system 100 includes a processing vessel 110 containing a processing fluid 112 and a lid 190 attached to the processing vessel 110. The processing vessel 110 includes (a) a fluid inlet 114 at the bottom of the vessel 110 through which the processing fluid 112 flows into the vessel 110, and (b) an overflow opening 116 proximate to the lid 190 through which the processing fluid 112 exits the vessel 110. The fluid inlet 114 may include a plurality of nozzles, and the overflow opening 116 can be a weir or other suitable structure. The processing vessel 110 may also include a diffuser (not shown) or other member positioned between the workpieces W and the fluid inlet 114 for conditioning the flow of the processing fluid 112 in the vessel 110. The illustrated system 100 further includes a pump 118 (shown schematically) coupled to the fluid inlet 114 for pumping the processing fluid 112 into the processing vessel 110. The processing fluid 112 can be DI water, aqueous hydrogen peroxide, or other suitable rinsing solutions.

The lid 190 is positioned over the processing vessel 110 and defines a chamber 192 above a surface 113 of the processing fluid 112. The lid 190 is coupled to a gas source 198 (shown schematically) and includes a gas inlet 194 for flowing gas into the chamber 192 and a gas outlet 196 for exhausting the gas from the chamber 192. The gas can be an inert gas, such as nitrogen, that does not substantially react or otherwise contaminate the workpieces W, the processing vessel 110, or the lid 190. The gas may also be a carrier gas laden with isopropyl alcohol (IPA) vapor to form a substantially continuous layer of drying liquid at the surface 113 of the processing fluid 112. Alternatively, an IPA vapor can be introduced into the lid 190 without a carrier gas to form the layer of drying liquid at the surface 113 of the processing fluid 112. In other embodiments, the drying liquid can be acetone, chloroform, methanol, carbon tetrachloride, benzene, ethanol, ethyl acetate, hexane, 1-propanol, 2-propanol, or other suitable liquids.

The system 100 further includes a workpiece mover 120 for pushing the workpieces W, a workpiece carrier 170 for carrying the workpieces W, an arm 180 for driving the workpiece mover 120, and a driving mechanism 188 (shown schematically) for actuating the arm 180. The workpiece carrier 170 can be a wafer boat or other apparatus for carrying the workpieces W during several processing steps. For example, the workpiece carrier 170 may hold the workpieces W during a chemical process, and after the chemical process, the workpieces W and the workpiece carrier 170 can be placed together in the processing vessel 110. Alternatively, the workpiece carrier 170 may remain in the processing vessel 110 and the workpieces W can be loaded into the workpiece carrier 170 in the system 100.

The illustrated workpiece mover 120 includes a leading portion 122, a trailing portion 124 opposite and positioned downstream from the leading portion 122, and an intermediate section 125 extending between the leading and trailing portions 122 and 124. The leading portion 122 is attached to the arm 180, and the trailing portion 124 is configured to contact a peripheral edge E of the individual workpieces W. The leading portion 122, the trailing portion 124, and the intermediate section 125 are configured to maintain a laminar flow or other desired flow properties. For example, the leading portion 122, the trailing portion 124, and the intermediate section 125 inhibit or otherwise mitigate turbulence in the flow F over the workpiece mover 120 to at least substantially maintain laminar flow over the workpiece W. The intermediate section 125 can have first and second arcuate surfaces 126 and 128, respectively. The illustrated first and second arcuate surfaces 126 and 128 have a gradual curvature that provides smooth flow surfaces for the processing fluid 112. Due to the curvature of the first and second arcuate surfaces 126 and 128, the thickness of the workpiece mover 120 is greatest at an intermediate section between the leading and trailing portions 122 and 124.

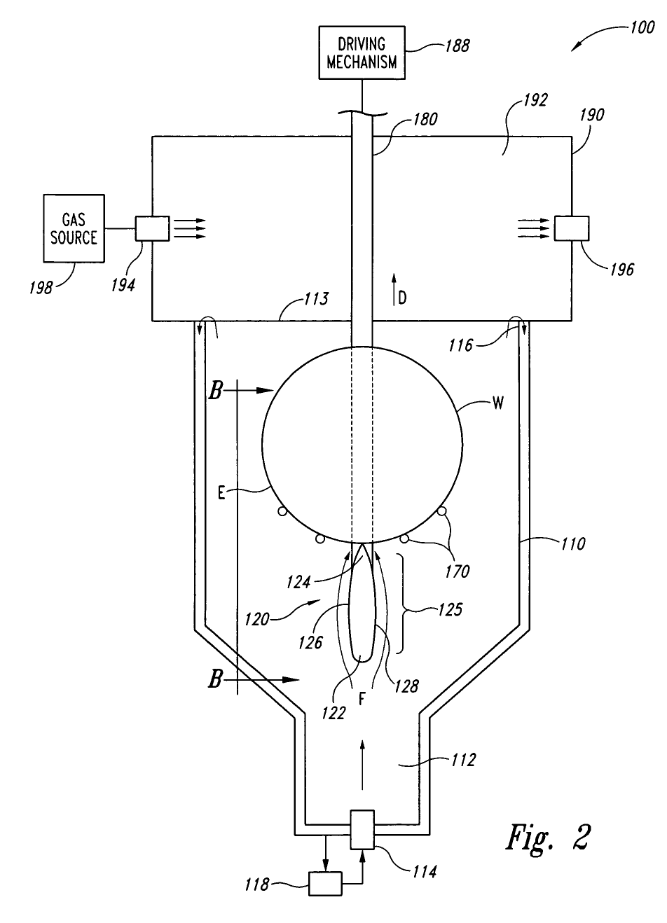

FIG. 3 is a schematic side view of the workpieces W (only three are shown), the workpiece mover 120, and the arm 180 taken substantially along the line B-B of FIG. 2. The illustrated arm 180 includes a first section 181 extending generally parallel to the workpieces W and a second section 182 projecting from the first section 181 in a direction generally parallel to the leading and trailing portions 122 and 124 of the workpiece mover 120. The second section 182 of the arm 180 has a portion 184 that contacts and is directly attached to the leading portion 122. The illustrated workpiece mover 120 also includes a first side 130, a second side 132 opposite the first side 130, and a channel 133 at the leading portion 122. The channel 133 extends from the first side 130 toward the second side 132 and is sized and shaped to partially receive the portion 184 of the arm 180. The leading portion 122 includes an arcuate section 123 between the channel 133 and the second side 132. The arcuate section 123 has a contour generally similar to the contour of an exposed surface 185 of the portion 184 of the arm 180. As such, the profile of the workpiece mover 120 and the arm 180 taken along a first plane X-X is generally similar to the profile of the workpiece mover 120 taken along a second plane Y-Y. In other embodiments, however, the workpiece mover 120 may not include a channel at the leading portion 122, the channel 133 may extend from the first side 130 to the second side 132, or the portion 184 of the arm 180 contacting the workpiece mover 120 may not include an exposed surface. For example, the arm 180 could be attached to the first side 130 of the workpiece mover 120 at an intermediate section between the leading and trailing portions 122 and 124.

The illustrated workpiece mover 120 further includes a plurality of first grooves 134 at the trailing portion 124 of the first arcuate surface 126 and a plurality of second grooves (not shown) at the trailing portion 124 of the second arcuate surface 128 (FIG. 2). The individual first grooves 134 in the first arcuate surface 126 are aligned with corresponding second grooves in the second arcuate surface 128. The intersection of each aligned pair of grooves 134 forms a recess 138. The recesses 138 are sized to receive a perimeter portion of corresponding workpieces W, and adjacent recesses 138 are spaced apart by projections 140.

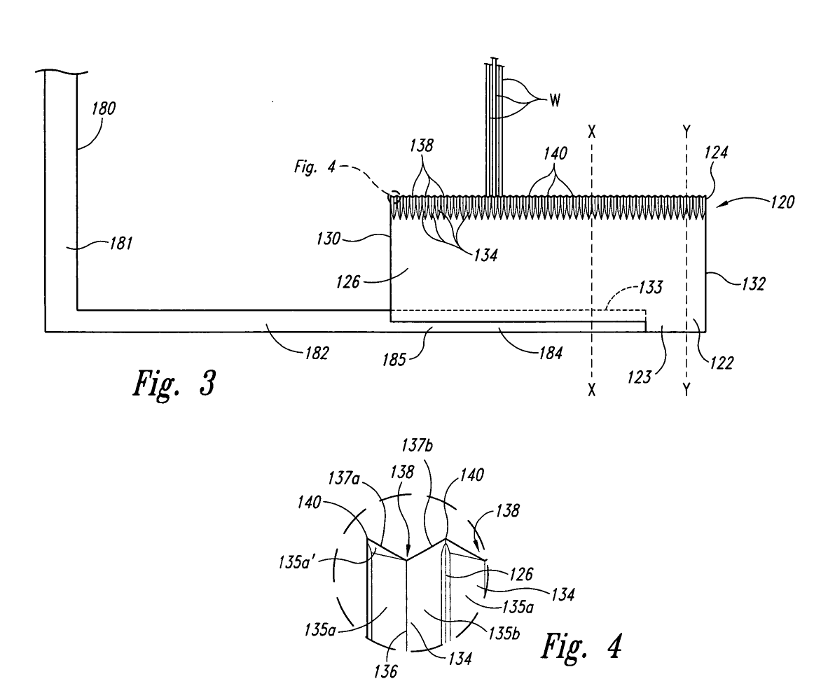

FIG. 4 is a schematic enlarged view showing a portion of the trailing portion 124 of the workpiece mover 120 of FIG. 3 in greater detail. The illustrated first and second grooves 134 include a first surface 135a, a second surface 135b, and a recessed edge 136 between the first and second surfaces 135a-b. The illustrated first surface 135a includes an angled section 135a′ at the distal end. As a result, the trailing portion 124 of the workpiece mover 120 includes (a) a plurality of first edges 137a between the angled sections 135a′ of the first grooves 134 and the second surface 135b of the aligned second grooves 134, and (b) a plurality of second edges 137b between the second surface 135b of the first grooves 134 and the angled section 135a′ of the aligned second grooves 134. The first and second edges 137a-b contact the peripheral edge E (FIG. 2) of the corresponding workpieces W when the perimeter portion of the workpieces W is placed in the recesses 138. In other embodiments, the trailing portion 124 of the workpiece mover 120 can have a different configuration. For example, the trailing portion 124 of a workpiece mover may not include the grooves 134, the recesses 138, and/or the projections 140.

Referring back to FIG. 2, in operation, the processing fluid 112 flows through the fluid inlet 114, around the exposed surface 185 (FIG. 3) of the arm 180 and the arcuate section 123 of the leading portion 122 of the workpiece mover 120, over the first and second arcuate surfaces 126 and 128 of the workpiece mover 120, across the individual workpieces W, and through the overflow opening 116. The processing fluid 112 rinses and cleans the surfaces of the workpieces W to remove chemical residue and other contaminants. While the processing fluid 112 flows across the workpieces W, the workpiece mover 120 pushes and moves the workpieces W in a direction D toward the lid 190. As the workpieces W move through the layer of drying liquid at the surface 113 of the processing fluid 112, the surface tension of the drying liquid pulls the processing fluid 112 and contaminants off the workpieces W such that the processing fluid 112 and contaminants are entrained beneath the layer of drying liquid. As a result, the workpieces W are dried as the workpiece mover 120 pushes the workpieces W through the layer of drying liquid and into the chamber 192. In several applications, the workpiece carrier 170 moves with the workpieces W to the top of the processing vessel 110, but does not move into the chamber 192. In other embodiments, however, the workpiece carrier 170 may move with the workpieces W into the chamber 192.

One feature of the system 100 illustrated in FIGS. 2-4 is that the workpiece mover 120 is shaped and configured so that the workpiece mover 120 does not disrupt the laminar flow of the processing fluid 112 in the processing vessel 110. For example, in contrast to conventional wafer pushers, the illustrated workpiece mover 120 has (a) an arcuate section 123 at the leading portion 122, (b) first and second arcuate surfaces 126 and 128 extending between the leading and trailing portions 122 and 124, and (c) a channel 133 (FIG. 3) configured to partially receive a portion 184 of the arm 180 so that the processing fluid 112 cannot flow between the workpiece mover 120 and a portion of the arm 180 upstream from the workpiece mover 120. The arcuate section 123 and the first and second arcuate surfaces 126 and 128 are configured to inhibit or otherwise mitigate turbulence in the flow over the workpiece mover 120. An advantage of this feature is that the processing fluid 112 flows across the workpieces W with a laminar flow, which removes chemical residue from the workpieces W, including the area of the individual workpiece W proximate to the point at which the workpiece mover 120 contacts the workpieces W. Removal of the chemical residue from the entire workpiece surface increases the yield of the structures and features on the workpieces W.

Another advantage of this feature is that the laminar flow of processing fluid 112 within the processing vessel 110 may augment the removal of contaminants from the workpieces W as the workpieces W pass through the layer of drying liquid at the surface 113 of the processing fluid 112. Specifically, turbulent flow at the surface 113 of the processing fluid 112 may create a nonuniform layer of drying liquid that does not remove contaminants consistently.

C. Additional Embodiments of Workpiece Movers and Arms

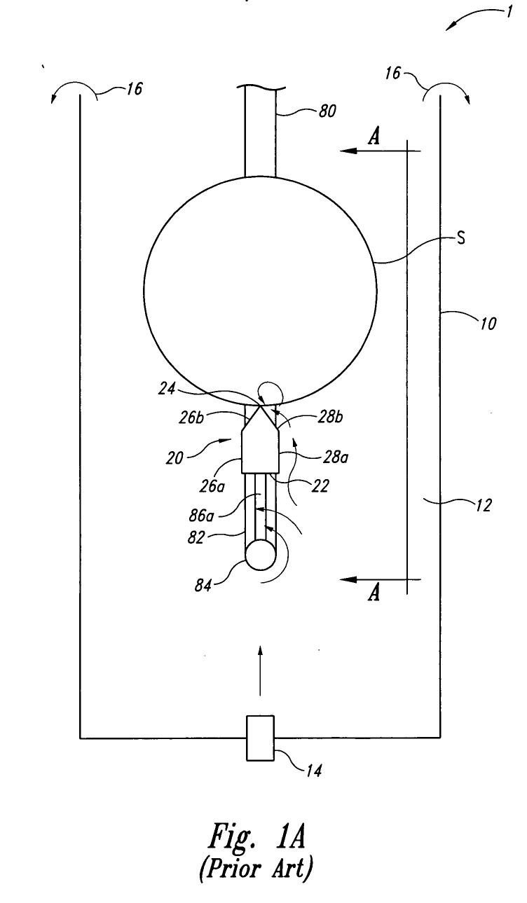

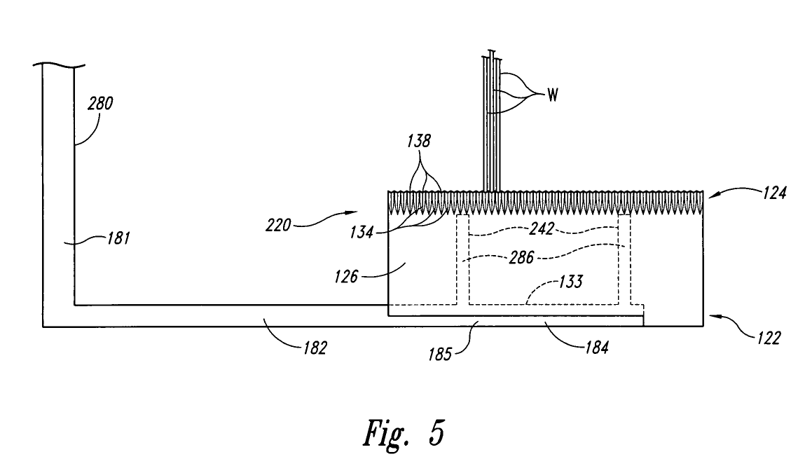

FIG. 5 is a schematic side view of a workpiece mover 220 and an arm 280 for use in a system for rinsing and/or drying a plurality of microfeature workpieces W (only three are shown). The workpiece mover 220 and the arm 280 are generally similar to the workpiece mover 120 and the arm 180, respectively, described above with reference to FIGS. 2-4. For example, the workpiece mover 220 includes a leading portion 122, a trailing portion 124 opposite the leading portion 122, a first arcuate surface 126 extending between the leading and trailing portions 122 and 124, a second arcuate surface (not shown) opposite the first arcuate surface 126 and extending between the leading and trailing portions 122 and 124, and a channel 133 at the leading portion 122. Moreover, the arm 280 includes a first section 181 extending generally parallel to the workpieces W and a second section 182 projecting from the first section 181 in a direction generally parallel to the leading and trailing portions 122 and 124. The second section 182 has a portion 184 partially received in the channel 133. In the illustrated embodiment, however, the workpiece mover 220 further includes a plurality of holes 242 (shown in broken lines) extending from the channel 133 toward the trailing portion 124, and the arm 280 further includes two members 286 (shown in broken lines) projecting from the portion 184 and received in corresponding holes 242. The illustrated arm 280 can be generally similar to conventional arms such as the arm 80 described above with reference to FIGS. 1A and 1B. Accordingly, an advantage of the illustrated workpiece mover 220 is that the mover 220 is configured for use with conventional arms.

From the foregoing, it will be appreciated that specific embodiments of the invention have been described herein for purposes of illustration, but that various modifications may be made without deviating from the spirit and scope of the invention. For example, many of the elements of one embodiment can be combined with other embodiments in addition to or in lieu of the elements of the other embodiments. Accordingly, the invention is not limited except as by the appended claims.

I/We claim:

1. A system for processing microfeature workpieces, the system comprising:
a processing vessel for receiving a plurality of microfeature workpieces;
an inlet through which a processing fluid can flow into the processing vessel; and
a workpiece mover for moving the microfeature workpieces in the processing vessel, the workpiece mover including a first end portion configured to contact a peripheral edge of the individual workpieces, a second end portion opposite and positioned upstream from the first end portion, and a third portion between the first and second end portions, wherein the first end portion has a first thickness, the second end portion has a second thickness, and the third portion has a third thickness greater than the first and second thicknesses.

2. The system of claim 1 wherein:
the workpiece mover further comprises (a) a first arcuate surface extending between the first and second end portions, and (b) a second arcuate surface opposite the first arcuate surface and extending between the first and second end portions;
the first end portion of the workpiece mover comprises a plurality of projections and a plurality of recesses, with the individual recesses positioned between adjacent projections;
the second end portion of the workpiece mover includes a channel and a section with an arcuate configuration; and
the system further comprises an arm coupled to the workpiece mover for driving the workpiece mover, the arm having a section in the processing vessel extending generally parallel to the second end portion of the workpiece mover, the section of the arm having a portion received at least partially in the channel of the workpiece mover.

3. The system of claim 1 wherein the workpiece mover further comprises:
a first arcuate surface extending between the first and second end portions; and
a second arcuate surface opposite the first arcuate surface and extending between the first and second end portions.

4. The system of claim 1 wherein the second end portion of the workpiece mover has a section with an arcuate configuration.

5. The system of claim 1, further comprising an arm coupled to the workpiece mover for driving the workpiece mover, the arm having a section in the processing vessel extending generally parallel to the second end portion of the workpiece mover, wherein the section of the arm is attached to the workpiece mover such that the processing fluid is inhibited from flowing between the second end portion of the workpiece mover and the section of the arm.

6. The system of claim 1, further comprising an arm coupled to the workpiece mover for driving the workpiece mover, the arm having a section in the processing vessel extending generally parallel to the second end portion of the workpiece mover, wherein the section of the arm contacts and is attached directly to the workpiece mover.

7. The system of claim 1 wherein the second end portion of the workpiece mover has a section with a channel.

8. The system of claim 1 wherein:
the second end portion of the workpiece mover has a section with a channel; and
the system further comprises an arm coupled to the workpiece mover for driving the workpiece mover, the arm having a section in the processing vessel extending generally parallel to the second end portion of the workpiece mover, wherein the section of the arm has a portion received at least partially in the channel of the workpiece mover.

9. The system of claim 1 wherein the first end portion of the workpiece mover comprises a plurality of projections and a plurality of recesses, with the individual recesses positioned between adjacent projections.

10. The system of claim 1, further comprising a lid attached to the processing vessel and at least partially defining a chamber over the processing fluid, wherein the workpiece mover is configured to move the workpieces at least partially into the chamber.

11. The system of claim 1 wherein the workpiece mover further comprises:
a first surface extending between the first and second end portions; and
a second surface opposite the first surface and extending between the first and second end portions;
wherein the first and second surfaces are configured such that the first and second surfaces do not change the flow of processing fluid from a laminar flow to a turbulent flow.

12. A system for processing microfeature workpieces, the system comprising:
a processing vessel for receiving a plurality of microfeature workpieces;
an inlet through which a processing fluid can flow into the processing vessel; and
a workpiece mover for moving the microfeature workpieces in the processing vessel, the workpiece mover including a first end portion configured to contact a peripheral edge of the individual workpieces, a second end portion opposite and positioned upstream from the first end portion, and an intermediate portion between the first and second end portions, wherein the first and second end portions and the intermediate portion are configured to maintain a laminar flow over the workpiece mover.

13. The system of claim 12 wherein the intermediate portion comprises:
a first arcuate surface extending between the first and second end portions; and
a second arcuate surface opposite the first arcuate surface and extending between the first and second end portions.

14. The system of claim 12 wherein the second end portion of the workpiece mover has a section with an arcuate configuration.

15. The system of claim 12, further comprising an arm coupled to the workpiece mover for driving the workpiece mover, the arm having a section in the processing vessel extending generally parallel to the second end portion of the workpiece mover, wherein the section of the arm is attached to the workpiece mover such that the processing fluid is inhibited from flowing between the second end portion of the workpiece mover and the section of the arm.

16. A system for rinsing and/or drying microfeature workpieces, the system comprising:
a processing vessel for receiving a microfeature workpiece;
an inlet through which a processing fluid can flow into the processing vessel;
a workpiece mover for pushing the microfeature workpiece in the processing vessel, the workpiece mover including a trailing end portion configured to contact a peripheral edge of the workpiece and a leading end portion opposite the trailing end portion; and
an arm coupled to the workpiece mover for driving the workpiece mover, the arm having a portion contacting and attached directly to the workpiece mover, wherein the portion of the arm extends in a direction generally parallel to the leading end portion of the workpiece mover.

17. The system of claim 16 wherein the workpiece mover further comprises an intermediate portion between the leading and trailing end portions, and wherein the trailing end portion has a first thickness, the leading end portion has a second thickness, and the intermediate portion has a third thickness greater than the first and second thicknesses.

18. The system of claim 16 wherein the workpiece mover further comprises:
a first arcuate surface extending between the leading and trailing end portions; and
a second arcuate surface opposite the first arcuate surface and extending between the leading and trailing end portions.

19. The system of claim 16 wherein the leading end portion of the workpiece mover has a section with an arcuate configuration.

20. The system of claim 16 wherein the leading end portion of the workpiece mover has a section with a channel.

21. The system of claim 16 wherein:
the leading end portion of the workpiece mover has a section with a channel; and
the portion of the arm has a portion received at least partially in the channel of the workpiece mover.

22. The system of claim 16 wherein the workpiece mover further comprises:
a first surface extending between the leading and trailing end portions; and
a second surface opposite the first surface and extending between the leading and trailing end portions;
wherein the first and second surfaces are configured such that the first and second surfaces do not change the flow of processing fluid from a laminar flow to a turbulent flow.

23. A microfeature workpiece mover for use in a system for rinsing and/or drying microfeature workpieces, the system including a processing vessel in which a batch of microfeature workpieces can be immersed in a processing fluid, the workpiece mover comprising a first end portion configured to contact a peripheral edge of the individual workpieces, a second end portion opposite the first end portion, a first arcuate surface extending between the first and second end portions, and a second arcuate surface opposite the first arcuate surface and extending between the first and second end portions.

24. The microfeature workpiece mover of claim 23 wherein the first and second arcuate surfaces are symmetrical.

25. The microfeature workpiece mover of claim 23 wherein the first end portion has a first thickness, the second end portion has a second thickness, and the third portion has a third thickness greater than the first and second thicknesses.

26. The microfeature workpiece mover of claim 23 wherein the second end portion has a section with an arcuate configuration.

27. The microfeature workpiece mover of claim 23 wherein the second end portion includes a section having a channel.

28. The microfeature workpiece mover of claim 23 wherein the first end portion of the workpiece mover comprises a plurality of projections and a plurality of recesses, with the individual recesses positioned between adjacent projections.

29. The microfeature workpiece mover of claim 23 wherein the first and second arcuate surfaces are configured such that the first and second surfaces do not change the flow of a processing fluid from a laminar flow to a turbulent flow.

30. A system for processing microfeature workpieces, the system comprising:
a processing vessel having a workpiece processing site configured to receive a plurality of microfeature workpieces;
an inlet through which a processing fluid can flow into the processing vessel; and
means for moving the microfeature workpieces in the processing site of the vessel without creating a turbulent flow of the processing fluid.

31. The system of claim 30 wherein the means for moving the microfeature workpiece comprise a workpiece mover including (a) a first end portion configured to contact a peripheral edge of the individual workpieces, (b) a second end portion opposite the first end portion, and (c) a third portion between the first and second end portions, and wherein the first end portion has a first thickness, the second end portion has a second thickness, and the third portion has a third thickness greater than the first and second thicknesses.

32. The system of claim 30 wherein the means for moving the microfeature workpiece comprise a workpiece mover including (a) a first end portion configured to contact a peripheral edge of the individual workpieces, (b) a second end portion opposite the first end portion, (c) a first arcuate surface extending between the first and second end portions, and (d) a second arcuate surface opposite the first arcuate surface and extending between the first and second end portions.

33. The system of claim 30 wherein:
the means for moving the microfeature workpiece comprise a workpiece mover including a channel; and
the system further comprises an arm coupled to the means for moving the microfeature workpiece, the arm having a portion received at least partially in the channel of the workpiece mover.

34. The system of claim 30 wherein the means for moving the microfeature workpiece comprise a workpiece mover including a plurality of projections and a plurality of recesses, with the individual recesses positioned between adjacent projections.

35. A method for processing microfeature workpieces, the method comprising:
positioning a plurality of microfeature workpieces in a processing vessel;
pushing the workpieces within the processing vessel with a workpiece mover; and
flowing processing fluid across the workpieces with a laminar flow to remove chemical residue from the workpieces.

36. The method of claim 35 wherein pushing the workpieces comprises contacting a peripheral edge of the individual workpieces with the workpiece mover.

37. The method of claim 35, further comprising delivering deionized water to the processing vessel.

38. The method of claim 35 wherein:
the workpiece mover comprises a first end portion configured to contact a peripheral edge of the individual workpieces, a second end portion opposite the first end portion, a first arcuate surface extending between the first and second end portions, and a second arcuate surface opposite the first arcuate surface and extending between the first and second end portions; and
the method further comprises flowing the processing fluid across the first and second arcuate surfaces of the workpiece mover.

39. The method of claim 35 wherein:
the workpiece mover comprises a first end portion configured to contact a peripheral edge of the individual workpieces and a second end portion opposite the first end portion, the second end portion having a section with an arcuate configuration; and
the method further comprises flowing the processing fluid proximate to the arcuate section of the workpiece mover.

40. The method of claim 35 wherein:
the workpiece mover comprises a first end portion configured to contact a peripheral edge of the individual workpieces and a second end portion opposite the first end portion;
pushing the workpieces within the processing vessel comprises driving the workpiece mover with an arm, the arm having a section in the processing vessel extending generally parallel to the second end portion of the workpiece mover; and
the method further comprises inhibiting the processing fluid from flowing between the second end portion of the workpiece mover and the section of the arm.

41. The method of claim 35 wherein:
the workpiece mover comprises a first end portion configured to contact a peripheral edge of the individual workpieces, a second end portion opposite the first end portion, and a channel in the second end portion; and
pushing the workpieces within the processing vessel comprises driving the workpiece mover with an arm at least partially received in the channel of the workpiece mover.

42. The method of claim 35, further comprising removing the workpieces from the processing fluid with the workpiece mover.

43. The method of claim 35, further comprising:
flowing an inert gas into a chamber over the processing fluid; and
moving the workpieces from the processing fluid to the chamber.

44. The method of claim 35, further comprising:
forming a generally continuous layer of a liquid at a surface of the processing fluid, the liquid being different than the processing fluid; and
moving the workpieces through the generally continuous layer of the liquid.

45. The method of claim 35, further comprising flowing the processing fluid across the workpiece mover without changing the flow of processing fluid from a laminar flow to a turbulent flow.

46. A method for rinsing and/or drying microfeature workpieces, the method comprising:
positioning a plurality of microfeature workpieces in a processing vessel;
moving the workpieces within the processing vessel with a workpiece mover; and
flowing a processing fluid across the workpiece mover without changing the fluid flow from a laminar flow to a turbulent flow.

47. The method of claim 46, further comprising flowing the processing fluid across the workpieces with a laminar flow.

48. The method of claim 46 wherein moving the workpieces comprises contacting a peripheral edge of the individual workpieces with the workpiece mover.

49. The method of claim 46 wherein flowing processing fluid comprises delivering deionized water to the processing vessel.

50. The method of claim 46 wherein:
the workpiece mover comprises a first end portion configured to contact a peripheral edge of the individual workpieces, a second end portion opposite the first end portion, a first arcuate surface extending between the first and second end portions, and a second arcuate surface opposite the first arcuate surface and extending between the first and second end portions; and
flowing the processing fluid across the workpiece mover comprises flowing the processing fluid across the first and second arcuate surfaces.

51. The method of claim 46 wherein:
the workpiece mover comprises a first end portion configured to contact a peripheral edge of the individual workpieces and a second end portion opposite the first end portion, the second end portion having a section with an arcuate configuration; and
flowing the processing fluid across the workpiece mover comprises flowing the processing fluid proximate to the arcuate section of the workpiece mover.

52. The method of claim 46 wherein:
the workpiece mover comprises a first end portion configured to contact a peripheral edge of the individual workpieces and a second end portion opposite the first end portion;
moving the workpieces comprises driving the workpiece mover with an arm, the arm having a section in the processing vessel extending generally parallel to the second end portion of the workpiece mover; and
the method further comprises inhibiting the processing fluid from flowing between the second end portion of the workpiece mover and the section of the arm.

53. The method of claim 46 wherein:
the workpiece mover comprises a first end portion configured to contact a peripheral edge of the individual workpieces, a second end portion opposite the first end portion, and a channel in the second end portion; and
moving the workpieces comprises driving the workpiece mover with an arm at least partially received in the channel of the workpiece mover.
